(19) United States
(12) Patent Application Publication
(10) Pub. No.: US 2018/0114192 A1
(43) Pub. Date: Apr. 26, 2018

(54) GENERATING A TRANSPORTATION ADVISOR REPORT BASED ON LOCATION DATA

(71) Applicant: GM GLOBALTECHNOLOGY OPERATIONS LLC, Detroit, MI (US)

(72) Inventor: Wade W. BRYANT, Grosse Pointe Farms, MI (US)

(21) Appl. No.: 15/332,905

(22) Filed: Oct. 24, 2016

(51) Int. Cl. G06Q 10/10; H04L 12/58; H04L 29/08; G06Q 30/02

(52) U.S. Cl. CPC G06Q 10/1093; H04L 51/08; G06Q 50/14; G06Q 30/0283; H04L 67/18

(57) ABSTRACT

A system and method of generating a transportation advisor report includes: receiving, at a computer, one or more transportation mode selections from a transportation consumer; receiving, at the computer, a travel schedule used by the transportation customer; determining, at the computer, the suitability of other transportation modes to the travel schedule; identifying the costs of using the other transportation modes for the travel schedule; and constructing an electronic message at the computer that includes the costs for the travel schedule based on transportation mode.

### TECHNICAL FIELD

The present invention relates to vehicles and, more particularly, to generating transportation advice based on vehicle routes used by a transportation consumer.

### BACKGROUND

People who consume transportation services now have an increasing array of choices for meeting their transportation needs. In addition to existing choices such as automobiles and trains, transportation consumers can also select from different types of automobile use. This includes not only traditional ownership but also automobile ownership by leasing, ridesharing, and use of transportation network companies for individual rides. Identifying the most efficient transportation can be difficult because the many different variables and their relative impact are not always available to the transportation consumer such that the consumer can accurately compare his or her options.

### SUMMARY

According to an embodiment of the invention, there is provided a method of generating a transportation advisor report. The method includes receiving, at a computer, one or more transportation mode selections from a transportation consumer; receiving, at the computer, a travel schedule used by the transportation customer; determining, at the computer, the suitability of other transportation modes to the travel schedule; identifying the costs of using the other transportation modes for the travel schedule; and constructing an electronic message at the computer that includes the costs for the travel schedule based on transportation mode.

According to another embodiment of the invention, there is provided a method of generating a transportation advisor report. The method includes receiving, at a computer, location data for one or more travel routes that is sent from a wireless device associated with a transportation consumer; receiving a transportation mode selection at the computer from the transportation consumer; identifying one or more other transportation modes capable of carrying out the travel routes; accessing cost data for the transportation mode selection received from the transportation consumer and each of the other transportation modes; generating a personal mobility report based on the cost data; and constructing an electronic message at the computer that includes the personal mobility report.

According to yet another embodiment of the invention, there is provided a system of generating a transportation advisor report. The system includes one or more computers configured to receive location data for one or more travel routes sent from a wireless device associated with a transportation consumer; receive a transportation mode selection from the transportation consumer for each travel route; access cost data for each transportation mode selection; calculate the cost for each of the travel routes based on the transportation mode selection and cost; calculate the cost of alternative transportation modes for each of the travel routes; construct an electronic message containing the calculated costs for each of the travel routes using both the transportation mode selection and one or more alternative transportation modes; and send the electronic message to the transportation consumer.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flow chart depicting an embodiment of a method of generating a transportation advisor report.

### DETAILED DESCRIPTION OF THE ILLUSTRATED EMBODIMENT(S)

The system and method described below uses location data that represents personal travel routes for a transportation consumer and the transportation modes available for travelling along these routes to provide analysis as well as advice to the transportation consumer. Personal travel data can be gathered from a number of sources. The transportation consumer can identify the vehicle types the consumer owns, his transportation schedule, the modes of transportation used, parking fees (if applicable), and travel preferences. The system can also access transportation costs not readily apparent to the transportation consumer or transportation costs that change over time. These transportation costs include vehicle insurance, vehicle maintenance, and opportunity costs associated with vehicle storage. The system can learn from the transportation consumer's behavior to confirm the transportation schedule, identify delays the consumer experiences along a route, and determine distances travelled by each mode of transportation.

In addition to the transportation consumer's personal travel data, the system can identify alternative transportation options for the consumer's travel routes. The system can determine whether the transportation consumer can walk, bike, taxi, ride a bus, ride a subway, ride a street car, ride a limousine, or use a ride provided by a transportation network company for a particular travel route. After identifying the modes of transportation that are feasible, the system can calculate costs for using one or more of these alternative transportation options for a route and generate an electronic message including these comparisons that is sent to the transportation consumer.

The alternative transportation options may relate to short-term analysis. But the system can also provide long-term analysis about buying, selling, and holding vehicle types using the location data provided by the transportation consumer and the costs of each transportation mode. For example, the system can consider the existing vehicle types owned by the transportation consumer and conclude whether changes should be made.

### Communications System—

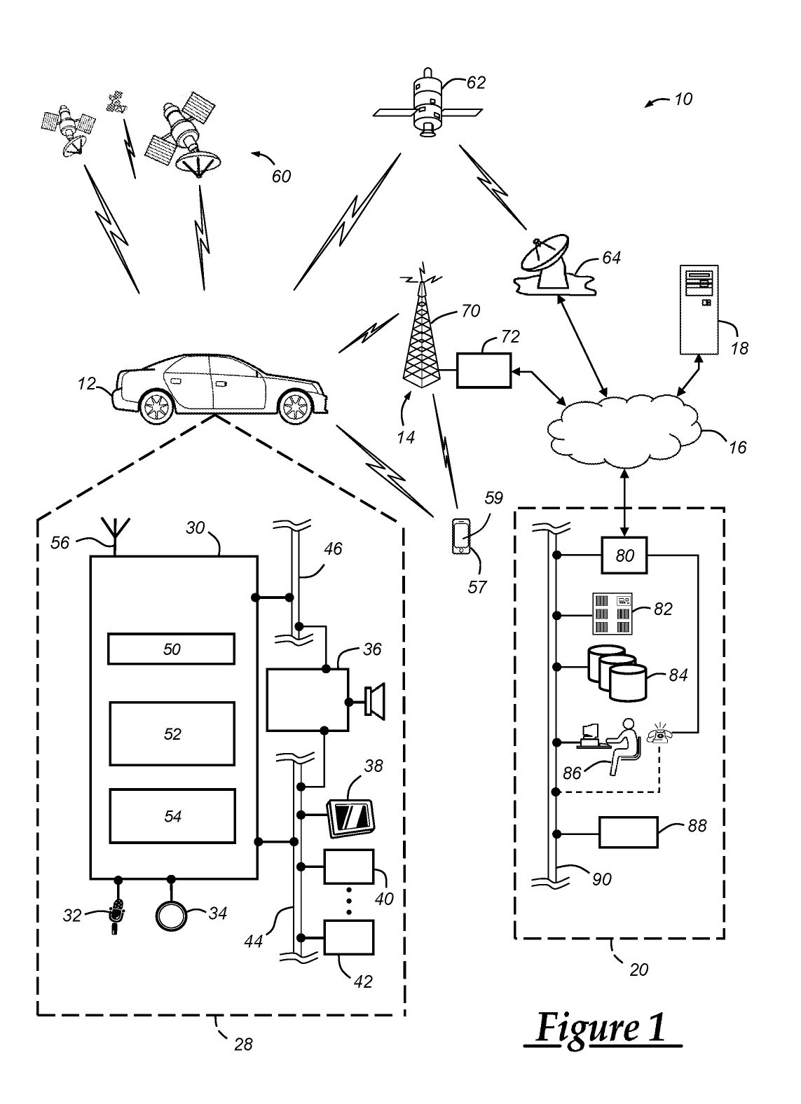

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, one or more computers 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of other vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is itself a vehicle system module (VSM) and can be implemented as an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™ Wi-Fi direct, Bluetooth™, or near field communication (NFC). When used for packet-switched data communication such as TCP/IP, the telematics unit can be configured with a static IP address or can be set up to automatically receive an assigned IP address from another device on the network such as a router or from a network address server.

One of the networked devices that can communicate with the telematics unit 30 is a wireless device, such as a smart phone 57. The smart phone 57 can include computer processing capability, a transceiver capable of communicating using a short-range wireless protocol, and a visual smart phone display 59. In some implementations, the smart phone display 59 also includes a touch-screen graphical user interface. The smart phone 57 can also include a GPS module capable of receiving GPS satellite signals and generating GPS coordinates based on those signals. The smart phone 57 also includes one or more microprocessors that execute machine code to generate logical output. Examples of the smart phone 57 include the iPhone manufactured by Apple and the Galaxy manufactured by Samsung, as well as others. While the smart phone 57 may include the ability to communicate via cellular communications using the wireless carrier system 14, this is not always the case. For instance, Apple manufactures devices such as the various models of the iPad and iPod Touch that include the processing capability, the display 59, the GPS module, and the ability to communicate over a short-range wireless communication link. However, the iPod Touch™ and some iPads™ do not have cellular communication capabilities. Even so, these and other similar devices may be used or considered a type of wireless device, such as the smart phone 57, for the purposes of the method described herein.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the telematics unit 30, audio system 36, and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbutton(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000 or 1xEV-DO) or GSM/GPRS (e.g., 4G LTE). As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or receiving transportation advisor report; or a third party repository to or from which vehicle data or other information is provided, whether by communicating with the vehicle 12 or call center 20, or both. The computer 18 can represent a plurality of computers that collectively form a computing resource that received input from the transportation consumer and also infers information from this input. The computer 18 may also receive information relating to the availability and cost of vehicle types. This information can be accessed from the Internet via the land network 16. In some implementations, the computer 18 may include an electronic message generating software module that can build electronic messages including personal travel data, transportation costs, and other information that are ultimately transmitted to the transportation consumer. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method—

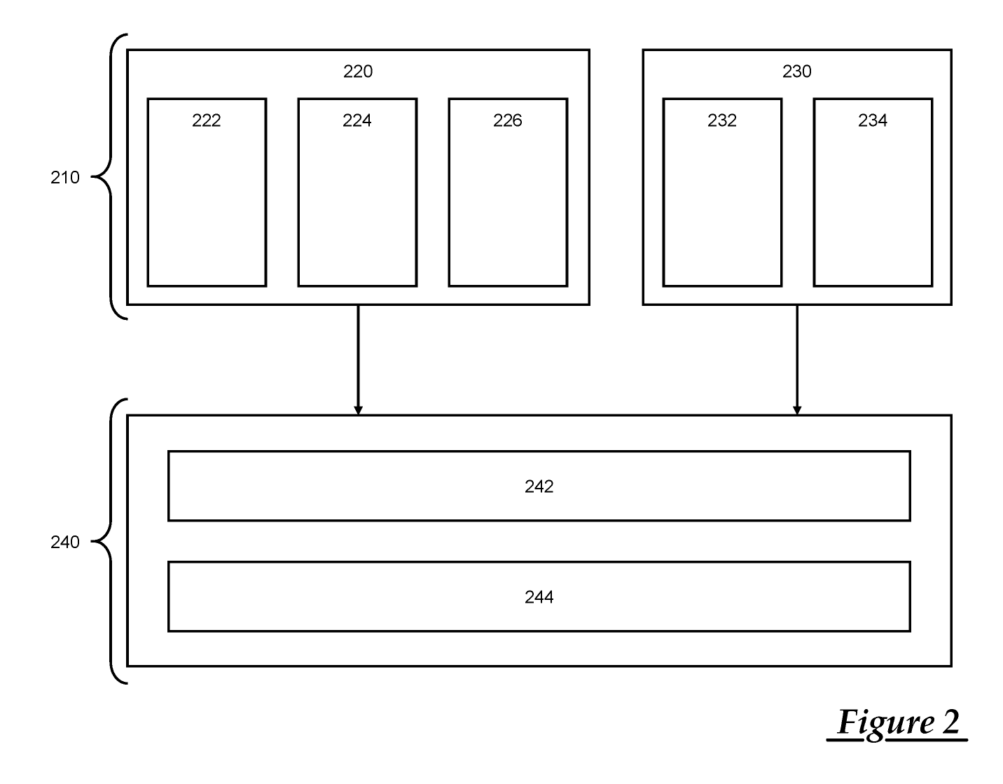

Turning now to FIG. 2, there is shown an embodiment of a method (200) of generating a transportation advisor report. The method (200) includes receiving travel inputs 210 that the computer 18 processes into the transportation advisor report 240. Travel inputs 210 can include personal travel data 220 and public travel data 230 that may be combined to render the transportation advisor report 240.

Personal travel data 220 can include customer input 222, vehicle transportation costs 224, and learned data 226 that can be inferred from the input 222, the costs 224, or both. A transportation consumer can refer to an individual or family of people who uses one or more modes of transportation to travel along personal travel routes. The transportation consumer can provide customer input 222 to the computer 18 that analyzes the travel needs of that consumer. For example, transportation consumer can identify the transportation modes that are presently used for travelling and, if the transportation modes include one or more vehicles, the ownership status of those vehicles. Vehicles can include automobiles using internal combustion engines, automobiles using electric propulsion, bicycles, and motorcycles to identify a few. The ownership status can indicate whether the transportation consumer owns or leases the vehicle. The transportation consumer can also provide one or more personal travel routes that identify, for each trip, its starting point and ending point, the transportation mode used for the trip, the time at which the trip starts, and the ending time of the trip. The customer input 222 can also include the costs to park at a beginning or an ending point and the amount of time a vehicle will remain parked before leaving. Other types of data can be received from the transportation consumer as well, including subjective travel preferences such as a preference to avoid toll roads or freeways or to travel by automobile.

The transportation consumer can provide customer inputs 222 to the computer 18 using a handheld wireless device, such as the smart phone 57. The smart phone 57 can receive the customer input 222 via the smart phone visual display 59 and wirelessly communicate the customer input 222 to the computer 18 via the wireless carrier system 14 and the land network 16. In some implementations, the smart phone 57 can passively gather the customer input 222 without the transportation consumer actively providing it. The smart phone 57 can monitor the movement of the transportation consumer (when the transportation consumer is an individual; a plurality of smart phones can monitor a family's movements) using a GPS module. When the consumer begins a route, the smart phone 57 can record the time of departure and detect when the person has arrived at a destination. This smart phone 57 can conclude that a destination has been reached when the phone 57 remains at a place for more than a defined amount of time. The smart phone 57 can also couple the time measurement with a determination that the smart phone 57 is located at a residence or place of business. This can eliminate falsely determining that a destination is reached when the transportation consumer is stopped in traffic. In other embodiments, the customer input 222 can be passively gathered by the vehicle telematics unit 30 when the transportation consumer is using the vehicle 12.

The vehicle transportation costs 224 can be received from the transportation consumer, inferred from the received customer input 222, or obtained from data sources available on the Internet. The vehicle transportation costs 224 can include the cost of insuring or maintaining a vehicle, such as an automobile or a motorcycle. These costs can also include the cost of parking somewhere else or the income that may be generated if a transportation consumer sold or leased the parking space(s) currently used for parking a vehicle. The computer 18 can access a database that includes the vehicle transportation costs 224; the database can be maintained either at the computer 18 or remotely. The computer 18 can also obtain data from other data sources accessible via the Internet.

The method 200 determines learned data 226 based on inferences from the customer input 222 and the transportation costs 224. These inferences can be made based on one or more data values obtained from customer input 222, transportation costs 224, or both. The learned data 226 can also be generated by monitoring the movement of the transportation consumer. In one implementation, the transportation consumer carries the smart phone 57, which monitors the movement of the consumer as discussed above. Or in another embodiment, the vehicle telematics unit 30 can monitor the movement of the vehicle 12 the transportation consumer drives to generate learned data 226 reflecting the travel patterns of the consumer. The movement of the transportation consumer can reflect the identity of frequently-used travel routes, delays the transportation consumer experiences, distances travelled along the travel routes, and the identity of different transportation modes used along the travel routes. The learned data 226 can also include parking fees a user pays, fuel consumption during travel, or electricity consumption during travel. In some implementations, the smart phone 57 can wirelessly receive fuel consumption data from the vehicle 12 via a short-range wireless link. In other implementations, the transportation consumer can provide the fuel/electricity consumption to the smart phone 57 by manually entering the information via the smart phone display 59.

In one example, the transportation consumer may drive the vehicle 12 from a residence to a train station and then take a train to the final destination. The computer 18 can determine the amount of time the transportation consumer waits between arriving the train station and boarding a train. In addition to the amount of time waiting to board the train, the computer 18 can identify the number of parking spots at the train station, determining the average wait time between arriving at the train station and parking the vehicle 12, and determining the cost per unit time of parking at the train station. The smart phone 57 can provide data to the computer 18 for making these determinations in some implementations. For example, the GPS module can determine how long the transportation consumer remains in the parking lot before moving to a dais of the train station and can also receive parking costs from the transportation consumer. The smart phone 57 can provide the data to the computer 18 via the wireless carrier system 14.

Other implementations can use a combination of the smart phone 57 and the vehicle telematics unit 30 to gather the data. For instance, the vehicle telematics unit 30 can monitor the vehicle location and detect that the vehicle 12 is operational. Once the vehicle 12 is parked and no longer operational, the vehicle telematics unit 30 can communicate the parked status to the computer 18. In addition, the vehicle telematics unit 30 can send a command via a short-range wireless protocol to the smart phone 57 to continue monitoring the location of the transportation consumer at the train station.

The computer 18 can also gather public travel data 230 that can be used along with the personal travel data 220 to generate the transportation advisor report 240. The public travel data 230 may include identifying the different transportation modes 232 the transportation consumer can use to travel along his or her scheduled routes. The computer 18 can identify a travel route and, using map data obtained from a mapping software module, determine other transportation modes that could be used along the route. Transportation modes can include walking, bicycling, riding in a taxi, using a transportation network company (e.g., Lyft), riding a bus, riding a subway or streetcar, or using a limousine. After identifying all of the transportation modes, the computer 18 can determine the availability of these modes during the time the transportation consumer usually embarks on the scheduled travel route. After eliminating the transportation modes that are unavailable during the scheduled travel route, the computer 18 can access the costs of using each transportation mode during the scheduled route. The computer 18 can maintain a database that includes the costs for each transportation mode at different times of day or the computer 18 can access data sources on the Internet.

The computer 18 can access transportation downtime data 234 that may relate to the different transportation modes 232. For example, if one of the transportation modes that may be used for the travel route is a train, the computer 18 can access the train schedule, determine if the transportation consumer would transfer trains along the travel route, and the calculated length of delay the transfer would add to the travel route when the train is used travel the route. The transportation downtime data 234 can also involve determining the transfer time that exists when the transportation consumer switches between two or more transportation modes long the travel route. For example, if the computer 18 calculates that the transportation consumer can use a combination of driving, walking, and riding a train, the computer 18 can calculate the amount of time it may take to walk from an parked automobile to the train station and how long the transportation consumer may wait at the train station.

The customer input 222, vehicle transportation costs 224, and learned data 226 can be combined by the computer 18 into a transportation advisor report 240. The transportation advisor report 240 can include a personal mobility report 242, personal mobility advice 244, or both. The transportation advisor report 240 can identify the travel routes used by the transportation consumer by starting point, destination point, route traveled between these points, and the transportation mode currently used to travel the route. The personal mobility report 242 can identify alternative transportation modes capable of travel along the identified routes the transportation consumer currently travels. In addition to the cost difference, the personal mobility report 242 can detail any differences in travel time, including travel delays associated with using the other transportation mode(s).

For example, if the transportation consumer drives from a residence to a school to drop off children and continues on to a business where the transportation consumer works, the personal mobility report 242 can identify other transportation modes for traveling the same route and the cost differences between the current transportation mode (vehicle) and alternatives. The report 242 may identify a train as an alternative transportation mode that includes two different trains involving a transfer between them. The report 242 can display the overall time between the starting point and the destination using the vehicle and using the train (including transfer time). In addition, the report 242 can identify the cost of traveling the route using the vehicle and the cost using the train. This cost can explicitly include costs unique for each mode of transportation. With respect to the vehicle, the report 242 can identify the cost of fuel, insurance, depreciation, parking, vehicle maintenance, and prorate these costs for each route traveled. In this way, the overall cost of vehicle use can be understood by the transportation consumer to include many hidden costs not clearly accounted for, such as insurance, depreciation, parking, and vehicle maintenance. These costs can be presented alongside the costs of using a train for the travel route. The costs of the train for the travel route can be presented as a fare price and any parking needed to arrive at the train station.

Similar cost comparisons with other transportation modes identified for the travel route and their respective costs can be included in the report 242 as well. Continuing the example above, the personal mobility report 242 can include, for the particular travel route, the costs associated with currently using the vehicle, the train costs, and also the cost of using a transportation network company. The report 242 can identify typical transportation costs using the transportation network company for the travel route at the desired time. The transportation consumer can then compare those costs to choose a transportation mode for the travel route. These comparisons can be presented for every travel route traveled by the transportation consumer. This can include a plurality of travel routes traveled by an individual, the travel routes for each member of a family, or the travel routes for each employee of a business.

In addition to or in lieu of the personal mobility report 242 the transportation advisor report 240 can include personal mobility advice 244 that applies to vehicles the transportation consumer owns or has legal possession to, the transportation modes currently used, and the travel routes currently used by the transportation consumer. This can be explained by continuing the example provided above. When the transportation consumer is provided alternative transportation modes that include a train or a vehicle provided by a transportation network company, the computer 18 can consider the cost of vehicle ownership attributed to the current transportation mode (vehicle) and provide long-range advice regarding changes to the current transportation mode. These changes can include recommending whether to keep the vehicle, sell the vehicle, or replace the vehicle with another mode of transportation. In this example, the personal mobility report 242 may inform the transportation consumer that the train is $5 a day less expensive than the vehicle the consumer presently owns. In a short-term framework the transportation consumer understands the marginal decrease in cost to use the train to travel the route. However, the personal mobility report 244 can advise the transportation consumer to sell the vehicle used to travel the route and identify the cost savings realized with the vehicle sale in addition to the marginal decrease in cost. The personal mobility report 244 can also identify the transportation mode or combination of transportation modes for a particular travel route that, in consideration of the inputs 210, provides the most economical way to travel along the route.

The computer 18 can generate the transportation advisor report 240 as an electronic message and transmit it to the transportation consumer. The electronic message can include an email message that is periodically sent to the transportation customer. Or in another implementation, the computer 18 can host a website accessible by the transportation consumer who views the information in the transportation advisor report 240 using a web browser. It is also possible to install a software application on the smart phone 57 that enables the transportation consumer to view the report 240 using a dedicated graphical user interface.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of generating a transportation advisor report, comprising the steps of:
(a) receiving, at a computer, one or more transportation mode selections from a transportation consumer;
(b) receiving, at the computer, a travel schedule used by the transportation customer;
(c) determining, at the computer, the suitability of other transportation modes to the travel schedule;
(d) identifying the costs of using the other transportation modes for the travel schedule; and
(e) constructing an electronic message at the computer that includes the costs for the travel schedule based on transportation mode.

2. The method of claim 1, wherein the transportation mode selections are received at a smart phone via a smart phone display.

3. The method of claim 1, further comprising the step of sending the electronic message from the computer to the transportation customer.

4. The method of claim 1, wherein the transportation consumer comprises an individual.

5. The method of claim 1, wherein the transportation consumer comprises a plurality of individuals in a family.

6. The method of claim 1, wherein the transportation consumer comprises a plurality of employees.

7. The method of claim 1, wherein the travel schedule is obtained by monitoring movement of the transportation customer.

8. A method of generating a transportation advisor report, comprising the steps of:
(a) receiving, at a computer, location data for one or more travel routes that is sent from a wireless device associated with a transportation consumer;
(b) receiving a transportation mode selection at the computer from the transportation consumer;
(c) identifying one or more other transportation modes capable of carrying out the travel routes;
(d) accessing cost data for the transportation mode selection received from the transportation consumer and each of the other transportation modes;
(e) generating a personal mobility report based on the cost data; and
(f) constructing an electronic message at the computer that includes the personal mobility report.

9. The method of claim 8, wherein the wireless device comprises a smart phone.

10. The method of claim 8, further comprising the step of sending the electronic message from the computer to the transportation customer.

11. The method of claim 8, wherein the transportation consumer comprises an individual.

12. The method of claim 8, wherein the transportation consumer comprises a plurality of individuals in a family.

13. The method of claim 8, wherein the transportation consumer comprises a plurality of employees.

14. The method of claim 8, wherein the location data is obtained by monitoring movement of the transportation customer.

15. The method of claim 8, wherein generating the personal mobility report comprises: calculating one or more cost differences between the selected transportation mode and the other vehicle type(e) based on the received location data and cost data.

16. A system of generating a transportation advisor report, the system comprising:
one or more computers configured to receive location data for one or more travel routes sent from a wireless device associated with a transportation consumer; receive a transportation mode selection from the transportation consumer for each travel route; access cost data for each transportation mode selection; calculate the cost for each of the travel routes based on the transportation mode selection and cost; calculate the cost of alternative transportation modes for each of the travel routes; construct an electronic message containing the calculated costs for each of the travel routes using both the transportation mode selection and one or more alternative transportation modes; and send the electronic message to the transportation consumer.
